(19) United States
(12) Patent Application Publication
(10) Pub. No.: US 2010/0054490 A1
(43) Pub. Date: Mar. 4, 2010

(54) Audio Noise Cancellation System

(75) Inventor: Aref Chowdhury, Berkeley Heights, NJ (US)

Correspondence Address: Jay M. Brown, 6409 Fayetteville Road, Suite 120-306, Durham, NC, 27713, US

(73) Assignee: LUCENT TECHNOLOGIES INC., Murray Hill, NJ (US)

(21) Appl. No.: 12/201,853

(22) Filed: Aug. 29, 2008

(51) Int. Cl. G10K 11/16

(52) U.S. Cl. 381/71.4

(57) ABSTRACT

System including signal processor in communication with sound detector and with sound-emitting device. Sound detector and sound-emitting device are in audio communication with occupant compartment. Signal processor is configured for receiving input signal from sound detector being indicative of background audio noise in occupant compartment, and for causing sound-emitting device to emit output sound that partially cancels background audio noise in manner responsive to received input signal. Another system, including array of sound detectors and array of sound-emitting devices. Method includes providing signal processor in communication with sound detector and sound-emitting device, where sound detector and sound-emitting device are in communication with occupant compartment. Further in method, signal processor is caused to receive input signal from sound detector being indicative of background audio noise in occupant compartment. Additionally in method, signal processor is induced to cause sound-emitting device to emit output sound that partially cancels background audio noise in manner responsive to received input signal.

### BACKGROUND OF THE INVENTION

1. Field of the Invention

This invention generally relates to systems and methods for reducing background audio noise.

2. Related Art

This section introduces aspects that may help facilitate a better understanding of the invention. Accordingly, the statements of this section are to be read in this light and are not to be understood as admissions about what is prior art or what is not prior art.

Various types of systems and methods have been developed for reducing background audio noise. Personal audio noise reduction devices are available, including earplugs and noise-reducing headphones. Soundproof rooms and sound-absorbing wall panels are also available. Despite these developments, there is a continuing need for improved systems and methods for reducing background audio noise.

### SUMMARY

In an example of an implementation, a system is provided. The system includes a sound detector, a sound-emitting device, and a signal processor in communication with the sound detector and with the sound-emitting device. The sound detector and the sound-emitting device are in audio communication with an occupant compartment. The signal processor is configured for receiving an input signal from the sound detector, being indicative of background audio noise in the occupant compartment. The signal processor is also configured for causing the sound-emitting device to emit output sound that partially cancels the background audio noise in a manner responsive to the received input signal.

As another example of an implementation, a system is provided that includes an array of sound detectors and an array of sound-emitting devices. The system also includes a signal processor in communication with the array of sound detectors and with the array of sound-emitting devices. The array of sound detectors and the array of sound-emitting devices are in audio communication with an occupant compartment. The signal processor is configured for receiving an input signal from each of the sound detectors, being indicative of background audio noise in the occupant compartment. The signal processor is further configured for causing the sound-emitting devices to emit output sound that partially cancels the background audio noise in a manner responsive to the received input signals.

In a further example of an implementation, a method is provided. The method includes providing a sound detector and a sound-emitting device, in communication with an occupant compartment. The method also includes providing a signal processor in communication with the sound detector and with the sound-emitting device. In the method, the signal processor is caused to receive an input signal from the sound detector. The input signal is indicative of background audio noise in the occupant compartment. The method also includes inducing the signal processor to cause the sound-emitting device to emit output sound that partially cancels the background audio noise in a manner responsive to the received input signal.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a schematic diagram showing an example of an implementation of a system.

FIG. 2 is a schematic diagram showing an example of an implementation of another system.

FIG. 3 is a flow chart showing an example of an implementation of a method.

### DETAILED DESCRIPTION

Silence is a luxury in a myriad of circumstances of modern life. For example, the coach passengers on an international flight often dream of the relative quiet in the first class section, while the first class passengers fitfully sleep in the presence of inescapable engine noise and other background audio noise including conversations from nearby passengers. Other types of passenger transport vehicles provide analogous examples of such problems with background audio noise. Minimized background audio noise is typically sought in a passenger transport vehicle, and may even be a marketable luxury option. In an industrial setting, workers are often chronically exposed to dangerously high amplitudes of background audio noise, even when wearing personal protection devices such as earplugs or headphones. In addition, earplugs and headphones cause other problems, because they impede workers from communicating with each other and may prevent workers from sensing and avoiding workplace hazards in a timely manner. Accordingly, systems and methods are provided herein for partially cancelling background audio noise in an occupant compartment in a manner responsive to a received input signal. As an example, an occupant compartment may be a passenger compartment in a passenger conveyance. It is understood throughout this specification that the term “occupant compartment” denotes a region of a partially- or completely-enclosed structure at least a part of which is intended to be occupied by one or more persons. It is understood throughout this specification that the term “passenger conveyance” denotes a mobile structure intended to transport one or more persons from place to place. It is understood throughout this specification that the term “passenger” denotes an occupant of a mobile structure being utilized to transport the occupant from one place to another.

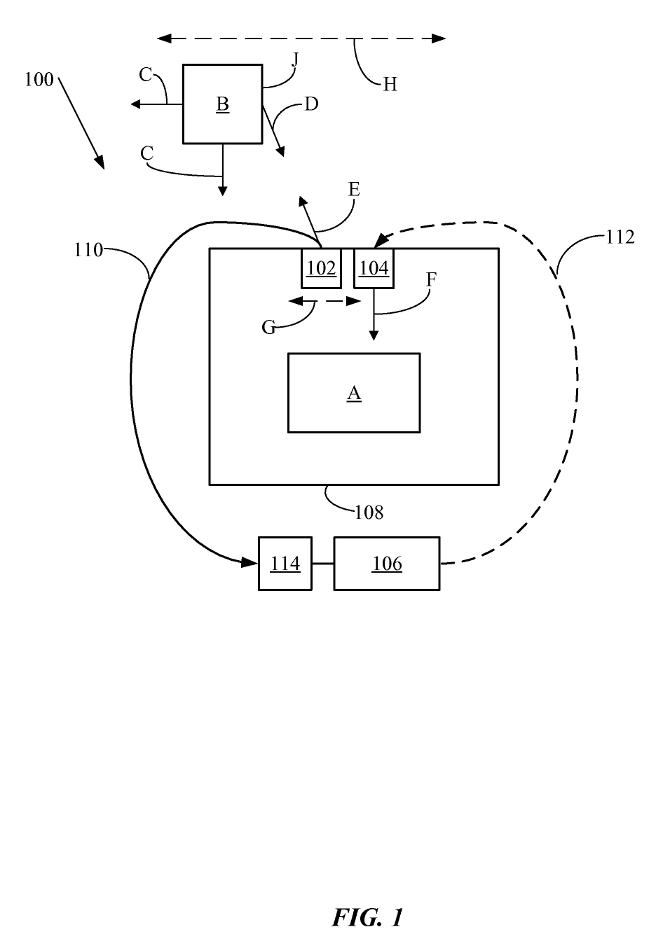

FIG. 1 is a schematic diagram showing an example of an implementation of a system 100. The system 100 includes a sound detector 102, a sound-emitting device 104, and a signal processor 106. The signal processor 106 is in communication with the sound detector 102 and with the sound-emitting device 104. The sound detector 102 and the sound-emitting device 104 are in audio communication with an occupant compartment 108. Further, the signal processor 106 is configured for receiving an input signal represented by the solid arrow 110 shown in FIG. 1, from the sound detector 102. The input signal 110 is indicative of background audio noise in the occupant compartment 108. Also, the signal processor 106 is configured for causing the sound-emitting device 104 to emit output sound represented by the dashed arrow 112 shown in FIG. 1. The output sound 112 emitted by the sound-emitting device 104 partially cancels the background audio noise in the occupant compartment 108, in a manner responsive to the received input signal 110. As an example, this partial cancellation may encompass a substantial region of the occupant compartment 108. It is understood throughout this specification that the term “substantial region” of an occupant compartment 108 means at least one-half of the volume of the occupant compartment 108.

In an example, the sound detector 102 may be a directional sound detector 102. The sound detector 102 in that example may be “directional” in being particularly sensitive to ambient sound arriving at the sound detector 102 from a range of directions (not shown). As another example, the sound-emitting device 104 may be a directional sound-emitting device 104. The sound-emitting device 104 in that example may be “directional” in being capable of emitting output sound focused in a range of directions (not shown) away from the sound-emitting device 104. It is understood throughout this specification, regarding any reference herein to a sound detector 102, that a directional sound detector 102 or another sound detector 102 such as a non-directional sound detector 102 may be utilized. It is understood throughout this specification, regarding any reference herein to a sound-emitting device 104, that a directional sound-emitting device 104 or another sound-emitting device 104 such as a non-directional sound-emitting device 104 may be utilized. The occupant compartment 108 may, for example, include a passenger seat A. As an example, a background audio noise source B may be positioned outside the passenger compartment 108. Background audio noise, schematically indicated by the arrows C, may emanate from the background audio noise source B. Background audio noise emanating from the background audio noise source B along the direction of the line D toward the passenger seat A may be expected to have a highest amplitude experienced by a passenger (not shown) sitting in the passenger seat A. A directional sound detector 102 may, for example, be positioned generally along the direction of the arrow E and oriented for maximum directional sensitivity along the direction E facing toward the background audio noise source B. A directional sound-emitting device 104 may be located, for example, close to the directional sound detector 102 and oriented for output of sound having highest amplitude emanating substantially along the direction of the arrow F toward the passenger seat A. As an example, the direction of the arrow F may be a substantially straight line. It is understood throughout this specification that a substantially straight line is a line is a line that deviates from a straight line by less than about six inches over a distance of ten feet. In an example, the output sound emitted by the directional sound-emitting device 104 along the direction F toward the passenger seat A may be a substantially inverted representation of the background audio noise from the background audio noise source B emanating in the direction D. For example, the directional sound-emitting device 104 may generate output sound that generally matches the background audio noise in amplitude and frequency, but which is shifted by a 180 degree (180°) phase inversion. Accordingly, the output sound emitted by the directional sound-emitting device 104 may at least partially interfere destructively, thus partially cancel, and hence reduce an average amplitude of the background audio noise from the background audio noise source B experienced by a passenger (not shown) sitting in the passenger seat A. As an example, such orientations of the directional sound detector 102 and the directional sound-emitting device 104 being located closely together may facilitate partial cancellation of the background audio noise, in a manner responsive to the background audio noise experienced by a passenger sitting in the passenger seat A. The directional sound detector 102 and the directional sound-emitting device 104 may, for example, be configured for repositioning with respect to various changed positions of the passenger seat A. If, as an example, a passenger (not shown) chooses to recline the passenger seat A or to return the passenger seat A to an upright position, the directional sound detector 102 and the directional sound-emitting device 104 may be configured to be moved or pivoted in a direction of the arrow G consistent with repositioning of the passenger seat A. As a further example (not shown), the directional sound detector 102 and the directional sound-emitting device 104 may be located in a ceiling or floor of the passenger compartment 108. Further, for example, the directional sound-emitting device 104 may include a plurality of directional sound-emitting devices each capable of emitting output sound within a different frequency range at suitable amplitudes for effective operation of the system 100.

In an example, the signal processor 106 may be configured for substantially reducing the average amplitude of the background audio noise. It is understood throughout this specification that “substantially reducing” the average amplitude of the background audio noise in an occupant compartment such as the occupant compartment 108 means reducing the average amplitude of such background audio noise in the occupant compartment by at least about one decibel (1 dB). As a further example, the signal processor 106 may be configured for reducing the average amplitude of such background audio noise in an occupant compartment such as the occupant compartment 108 by at least about three (3) dB, qualitatively representing a background audio noise reduction of about fifty percent. It is understood throughout this specification that an average amplitude of the background audio noise in an occupant compartment such as the occupant compartment 108 may be approximately determined by measuring the amplitude of the background audio noise at a minimum of two (2) spaced-apart measurement locations distributed in the occupant compartment. The spaced-apart measurement locations may for example include, for each point where a person may be expected to be positioned at some time within the occupant compartment such as the occupant compartment 108, a generally representative measurement location. For example, background audio noise may be measured at one location in the vicinity of each passenger seat A located within the occupant compartment 108.

In an example, the signal processor 106 may be configured for causing the sound-emitting device 104 to emit output sound 112 that is substantially inverted relative to the input signal 110. It is understood throughout this specification that “substantially inverted” output sound 112 is output sound 112 having substantially a counter propagation path relative to the input signal 110 and being approximately 180° out of phase with respect to the input signal 110. Emitting such substantially inverted output sound 112 through the sound-emitting device 104 typically reduces the average amplitude of the background audio noise by at least about one (1) dB in the occupant compartment 108. As a further example, the signal processor 106 may be configured for generating substantially inverted output sound 112 such that emitting the output sound 112 through the sound-emitting device 104 reduces the average amplitude of the background audio noise by at least about three (3) dB in the occupant compartment 108.

As examples, the occupant compartment 108 may form all or part of (not shown) a building, amphitheatre, passenger seating or waiting area, mobile industrial machine, or analogous structure, any of which may or may not be partially or fully defined by a floor, walls and/or a ceiling. Mobile industrial machines (not shown) may include, as examples, farming equipment, mining equipment, construction equipment, and load-lifting and load-transporting equipment such as cranes and forklifts. In further examples, the occupant compartment 108 may include a passenger compartment 108 located in a passenger conveyance (not shown). In examples, the passenger conveyance may be a passenger transport vehicle such as an automobile, a bus, a truck, an aircraft, a ship, a boat, a submarine, a spacecraft, or a railroad car. Such a passenger compartment 108 may include, for example, one or an array of passenger seats A for seating of passengers (not shown).

As another example, the signal processor 106 may include a filter 114 configured for removing an audio information signal from the input signal 110 before generating the output sound 112. As an example, the occupant compartment 108 may be configured for broadcasting an audio information signal intended to be heard by a passenger at the passenger seat A within the occupant compartment 108, such as a public address audio information signal, a passenger entertainment audio information signal, or both. For example, a passenger entertainment audio information signal may include a movie soundtrack, music, or a book on tape transcript. In that example, the filter 114 may be configured for removing public address and passenger entertainment audio information signals from the input signal 110 before generating the output sound 112. In this manner, the system 100 may both partially cancel the background audio noise in the occupant compartment 108, and facilitate unimpeded listening to public address and public entertainment audio information signals by passengers within the occupant compartment 108.

In an example of operation of the system 100, the sound detector 102 and the sound-emitting device 104 may be in audio communication with a passenger compartment 108 of a passenger conveyance (not shown). The signal processor 106 may, for example, be installed on-board the passenger conveyance at a suitable position (not shown), and configured so as to be in communication with the sound detector 102 and the sound-emitting device 104.

As an example, the passenger compartment 108 may be located in an aircraft (not shown). The aircraft (not shown) may include an engine B located outside a fuselage of the aircraft at a position nearby a passenger seat A located inside the passenger compartment 108. Background audio noise, schematically indicated by the arrows C, may emanate from the engine B. Background audio noise emanating from an air intake (not shown) of the engine B along the direction of the line D toward the passenger seat A may be expected to have a highest amplitude experienced by a passenger (not shown) sitting in the passenger seat A. The sound detector 102 may, for example, be positioned generally along the direction of the arrow E and oriented for maximum directional sensitivity along the direction E facing toward the engine B. The sound-emitting device 104 may be located, for example, close to the sound detector 102 and oriented for output of sound having highest amplitude emanating substantially along the direction of the arrow F toward the passenger seat A. In an example, the output sound emitted by the sound-emitting device 104 along the direction F toward the passenger seat A may be a substantially inverted representation of the background audio noise from the engine B emanating in the direction D. For example, the sound-emitting device 104 may generate output sound that generally matches the background audio noise in amplitude and frequency, but which is shifted by a 180° phase inversion. Accordingly, the output sound emitted by the sound-emitting device 104 may at least partially interfere destructively, thus partially cancel, and hence reduce an average amplitude of the background audio noise from the engine B experienced by a passenger (not shown) sitting in the passenger seat A. As an example, such orientations of the sound detector 102 and the sound-emitting device 104 being located closely together may facilitate substantial cancellation of background audio noise experienced by a passenger sitting in the passenger seat A. It is understood throughout this specification that substantial cancellation of background audio noise means reduction of such noise below a threshold of hearing by a typical human ear. As an example, this substantial cancellation may encompass a substantial region of the occupant compartment 108. As another example, such cancellation may be localized to a small region around the passenger's head. The sound detector 102 and the sound-emitting device 104 may, for example, be configured for repositioning with respect to changing positions of the passenger seat A. If, as an example, a passenger (not shown) chooses to recline the passenger seat A or to return the passenger seat A to an upright position, the sound detector 102 and the sound-emitting device 104 may be configured to be moved or pivoted in a direction of the arrow G consistent with repositioning of the passenger seat A. As a further example (not shown), the sound detector 102 and the sound-emitting device 104 may be located in a ceiling or floor of the passenger compartment 108. Further, for example, the sound-emitting device 104 may include a plurality of sound-emitting devices (not shown) each capable of emitting output sound within a different frequency range at suitable amplitudes for effective operation of the system 100.

As another example, the passenger compartment 108 may be located in a bus (not shown) moving along a road in a direction of the arrow H. Another vehicle J also moving along the road in a direction of the arrow H may include an engine B. Background audio noise, schematically indicated by the arrows C, may emanate from the engine B of the vehicle J toward the passenger compartment 108. Background audio noise emanating from the vehicle J along the direction of the line D toward the passenger seat A may be expected to have a highest amplitude experienced by a passenger (not shown) sitting in the passenger seat A. The sound detector 102 may, for example, be positioned generally along the direction of the arrow E and oriented for maximum directional sensitivity along the direction E facing toward the engine B. As another example, the sound detector 102 may be positioned generally within a range of directions that includes the direction of the arrow E, and may be oriented for maximum directional sensitivity along the range of directions E between the passenger seat A and a corresponding range of potential positions of the engine B as the vehicle J moves relative to the passenger compartment 108. The sound-emitting device 104 may be located, for example, close to the sound detector 102 and oriented for output of sound having highest amplitude emanating substantially along the direction of the arrow F toward the passenger seat A. In an example, the output sound emitted by the sound-emitting device 104 along the direction F toward the passenger seat A may be a substantially inverted representation of the background audio noise from the engine B emanating in the direction D. Accordingly, the output sound emitted by the sound-emitting device 104 may at least partially interfere destructively with, thus partially cancel, and hence reduce an average amplitude of the background audio noise from the vehicle J experienced by a passenger (not shown) sitting in the passenger seat A. As an example, such orientations of the sound detector 102 and the sound-emitting device 104 being located closely together may facilitate substantial cancellation of the background audio noise experienced by a passenger sitting in the passenger seat A. The sound detector 102 and the sound-emitting device 104 may, for example, be configured for repositioning with respect to changing positions of the passenger seat A, as earlier discussed.

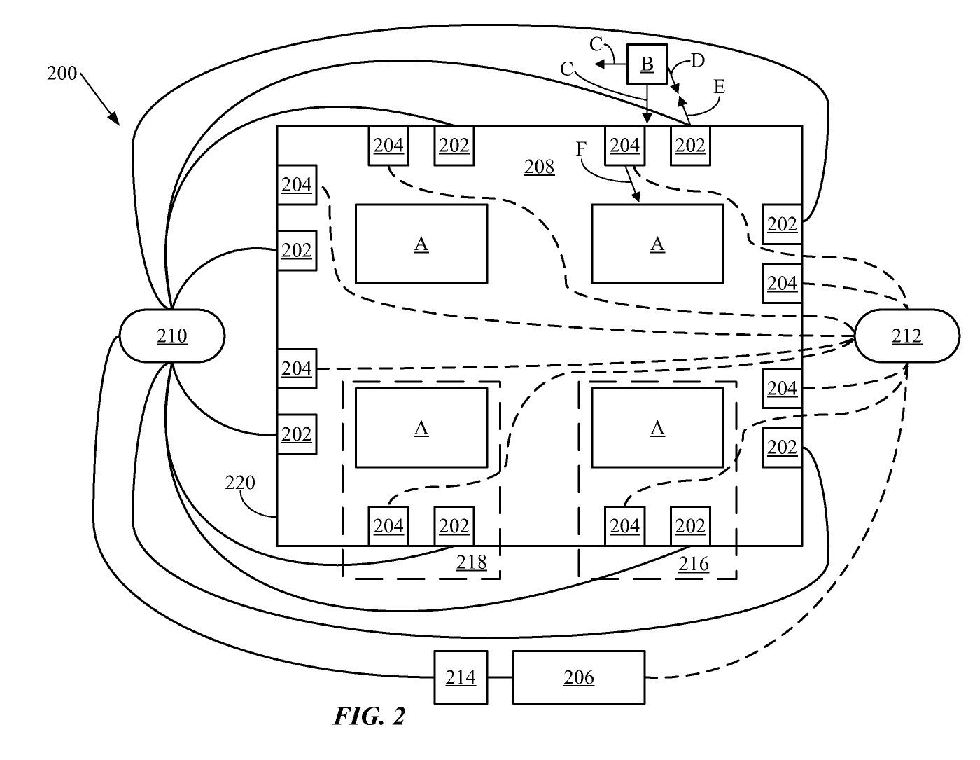

FIG. 2 is a schematic diagram showing an example of an implementation of another system 200. The system 200 includes an array of sound detectors 202, and an array of sound-emitting devices 204. The system 200 further includes a signal processor 206 in communication with the array of sound detectors 202 and with the array of sound-emitting devices 204. The array of sound detectors 202 and the array of sound-emitting devices 204 are in audio communication with an occupant compartment 208. The signal processor 206 is configured for receiving, from each of the sound detectors 202, an input signal schematically represented by a solid line intersecting with an ellipse 210 being indicative of background audio noise in the occupant compartment 208. The signal processor 206 is further configured for causing the sound-emitting devices 204 to emit output sound schematically represented by a dashed line intersecting with an ellipse 212, that partially cancels the background audio noise in a manner responsive to the received input signals 210. As an example, this partial cancellation may encompass a substantial region of the occupant compartment 208. It is understood throughout this specification that the term “substantial region” of an occupant compartment 208 means at least one-half of the volume of the occupant compartment 208. As another example, such cancellation may be localized to a small region around the passenger's head. It is understood throughout this specification that the lines intersecting with ellipses 210, 212 schematically represent examples of circuit layouts for carrying the input signals and output sounds respectively, and that other circuit layouts are contemplated. It is further understood throughout this specification that a system 200 may include a plurality (not shown) of signal processors 206.

In an example, the sound detectors 202 may directional sound detectors 202. Each of the sound detectors 202 in that example may be “directional” in being particularly sensitive to ambient sound arriving at the sound detector 202 from a range of directions (not shown). As another example, the sound-emitting devices 204 may be directional sound-emitting devices 204. Each of the sound-emitting devices 204 in that example may be “directional” in being capable of emitting output sound focused in a range of directions (not shown) away from the sound-emitting device 204. It is understood throughout this specification, regarding in any reference herein to a sound detector 202, that a directional sound detector 202 or another sound detector 202 such as a non-directional sound detector 202 may be utilized. It is understood throughout this specification, regarding any reference herein to a sound-emitting device 204, that a directional sound-emitting device 204 or another sound-emitting device 204 such as a non-directional sound-emitting device 204 may be utilized.

In an example, the signal processor 206 may be configured for substantially reducing the average amplitude of the background audio noise in the occupant compartment 208. As a further example, the signal processor 206 may be configured for reducing the average amplitude of such background audio noise by at least about three (3) dB, qualitatively representing a reduction of the average amplitude of the background audio noise by a magnitude of about fifty percent. In another example, the signal processor 206 may be configured for causing the sound-emitting devices 204 to emit output sound 212 that is an inverted representation of the input signal 210. Further, for example, the signal processor 206 may be configured for causing the sound-emitting devices 204 to emit output sound 212 that is a substantially inverted representation of the input signal 210. As a further example, the signal processor 206 may be configured for causing the sound-emitting devices 204 to emit substantially inverted output sound 212 that reduces the average amplitude of the background audio noise by at least about three (3) dB in the occupant compartment 208.

As examples, the occupant compartment 208 may form all or part of (not shown) a building, amphitheatre, passenger seating or waiting area, mobile industrial machine, or another structure, any of which may or may not be partially or fully defined by a floor, walls and/or a ceiling. In further examples, the occupant compartment 208 may include a passenger compartment 208 in a passenger conveyance (not shown). Such a passenger compartment 208 may, for example, include one or an array of passenger seats A for seating of passengers (not shown). Further, for example, the passenger compartment 208 may be included in a passenger conveyance (not shown). In examples, the passenger conveyance may be a passenger transport vehicle such as an automobile, a bus, a truck, an aircraft, a ship, a boat, a submarine, a spacecraft, or a railroad car.

As another example, the signal processor 206 may include a filter 214 configured for removing an audio information signal from the input signal 210 before generating the output sound 212. As an example, the occupant compartment 208 may include one or an array of passenger seats A and the occupant compartment 208 may be configured for broadcasting an audio information signal intended to be heard by passengers within the occupant compartment 208, such as a public address audio information signal, a passenger entertainment audio information signal, or both. In that example, the filter 214 may be configured for removing public address and passenger entertainment audio information signals from the input signal 210 before the system 200 generates the output sound 212. In an example, the signal processor 206 may generate and transmit a signal indicative of the output sound 212 to the sound-emitting devices 204. In this manner, the system 200 may both partially cancel the background audio noise in a manner responsive to the received input signal 210, and facilitate unimpeded listening to public address and public entertainment audio information signals by passengers within the occupant compartment 208. In another example, the signal processor 206 may be configured in other ways to minimize interference by the system 200 with the broadcasting of a public address or public entertainment audio information signal intended to be heard by passengers located within the occupant compartment 208. For example, the signal processor 206 may be configured to suspend causing the sound-emitting devices 204 to emit the output sounds 212 during the broadcasting of a public address or public entertainment audio information signal.

In an example, the signal processor 206 may be configured for analyzing a different one of a plurality of input signals 210 in causing the sound-emitting devices 204 to emit each of a plurality of output sounds 212. As an additional example, the signal processor 206 may be configured for partially cancelling the background audio noise by a substantially similar magnitude throughout the occupant compartment 208. It is understood throughout this specification that a “substantially similar magnitude” in this context means a magnitude not representing a noticeable difference to a typical human ear. In another example, each one of the array of sound detectors 202 may be paired with one of the array of sound-emitting devices 204, together forming one of an array of pairs each including a sound detector 202 and a sound-emitting device 204. In that example, the signal processor 206 may be configured for receiving a separate input signal 210 from each one of the sound detectors 202 and for causing the paired sound-emitting device 204 in each of the array of pairs to emit a separate output sound 212. Further, for example, the signal processor 206 may include a plurality (not shown) of filters 214, such as one filter 214 paired with each sound detector 202. As an example, a plurality of filters 214 each paired with sound detectors 202 may be configured for separately removing public address and passenger entertainment audio information signals from the input signal 210 generated by each sound detector 202 before generating the corresponding output sound 212 to a paired sound-emitting device 204. Also, for example, the occupant compartment 208 may include, collectively represented by a dashed line defining a three-dimensional region 216, a first pair that includes a first sound detector 202 and a first sound-emitting device 204, adjacent to a first passenger seat A. Further, for example, the occupant compartment 208 may include, collectively represented by a dashed line defining a three-dimensional region 218, a second pair that includes a second sound detector 202 and a second sound-emitting device 204, adjacent to a second passenger seat A.

In that example, the signal processor 206 may be configured for partially cancelling background audio noise in a region extending between the first and second passenger seats located in the three-dimensional regions 216, 218, respectively. In an example, the signal processor 206 may be configured for substantially reducing the average amplitude of the background audio noise in the region extending between the first and second passenger seats. It is understood throughout this specification that “substantially reducing” background audio noise in a region extending between first and second passenger seats located in the three-dimensional regions 216, 218 means reducing by at least about one decibel (1 dB) an average amplitude of background audio noise received at either one of the two passenger seats from the other one of the two passenger seats. As a further example, the signal processor 206 may be configured for reducing the background audio noise in a region extending between such examples of first and second passenger seats by at least about three (3) dB, qualitatively representing a reduction of the average amplitude of background audio noise by a magnitude of about fifty percent.

In an example of operation of the system 200, the sound detectors 202 and the sound-emitting devices 204 may be located in a passenger compartment 208 of a passenger conveyance (not shown). The signal processor 206 may, for example, be installed on-board the passenger conveyance at a suitable position (not shown), and configured so as to be in communication with the sound detectors 202 and the sound-emitting devices 204.

As an example, the passenger compartment 208 may be located in an aircraft (not shown). The aircraft (not shown) may include an engine B located outside a fuselage of the aircraft at a position nearby a passenger seat A located inside the passenger compartment 208. Background audio noise, schematically indicated by the arrows C, may emanate from the engine B. Background audio noise emanating from an air intake (not shown) of the engine B along the direction of the line D toward the passenger seat A may be expected to have a highest amplitude experienced by a passenger (not shown) sitting in the passenger seat A. The sound detectors 202 may, for example, be positioned generally along the direction of the arrow E and oriented for maximum directional sensitivity along the direction E facing toward the engine B. The sound-emitting devices 204 may be located, for example, close to the sound detectors 202 and oriented for output of sound having highest amplitudes emanating substantially along the direction of the arrow F toward the passenger seat A. As an example, the direction of the arrow F may be a substantially straight line. In an example, the output sound emitted by the sound-emitting devices 204 along the direction F toward the passenger seat A may be a substantially inverted representation of the background audio noise from the engine B emanating in the direction D. For example, the sound-emitting devices 204 may emit output sound that generally matches the background audio noise in amplitude and frequency, but which are shifted by a 180° phase inversion.

As another example, the system 200 may include a single sound detector 202 for detecting background audio noise from the engine B in the occupant compartment 208. Further in that example, the signal processor 206 may utilize the input signal 210 from the sound detector 202 in causing a single sound-emitting device 204, or the array of sound-emitting devices 204 shown in FIG. 2, to emit output sound 212.

In an example, the array of sound detectors 202 may be distributed along a perimeter 220 of the occupant compartment 208. Accordingly, the array of sound detectors 202 may be capable of monitoring background audio noise throughout the occupant compartment 208. Further, for example, the array of sound-emitting devices 204 may likewise be distributed along the perimeter 220 of the occupant compartment 208. In this manner, for example, the array of sound-emitting devices 204 may be caused to emit output sound throughout the occupant compartment 208, where the thus-emitted output sound 212 may be configured for destructively interfering with and accordingly for partially cancelling and for reducing the average amplitude of the background audio noise in the occupant compartment 208.

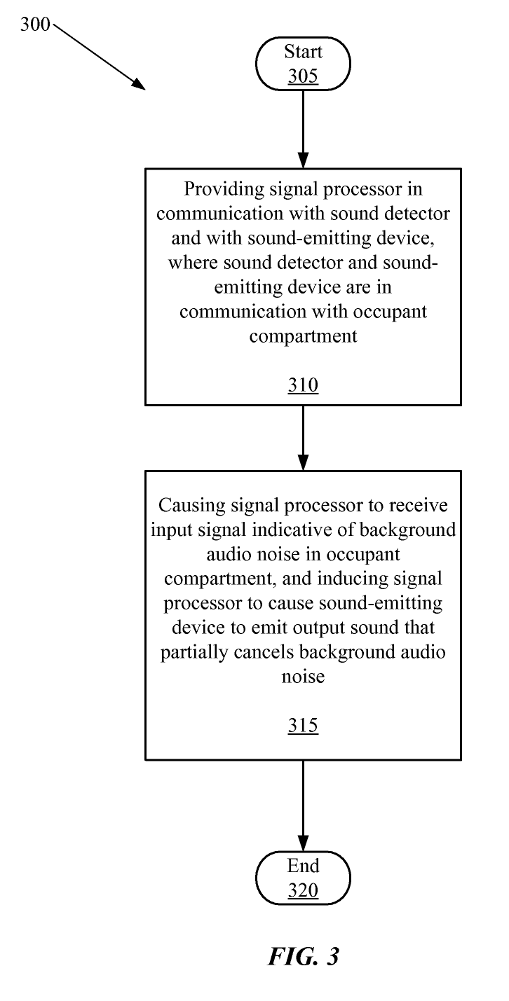

FIG. 3 is a flow chart showing an example of an implementation of a method 300. The method 300 starts at step 305. Step 310 includes providing one or an array of sound detectors 102, 202 and one or an array of sound-emitting devices 104, 204 in communication with an occupant compartment 108, 208, and providing a signal processor 106, 206 in communication with the sound detectors 102, 202 and with the sound-emitting devices 104, 204. Step 315 includes causing the signal processor 106, 206 to receive an input signal 110, 210 from the sound detectors 102, 202. The input signal 110, 210 is indicative of background audio noise in the occupant compartment 108, 208. Step 315 also includes inducing the signal processor 106, 206 to cause the sound-emitting devices 104, 204 to emit output sound 112, 212. The output sound 112, 212 partially cancels the background audio noise in the occupant compartment 108, 208, in a manner responsive to the received input signal 110, 210. The method may then end at step 320.

As an example, the partial cancellation in step 315 may encompass a substantial region of the occupant compartment 108, 208. In an example, step 315 may include causing the sound-emitting devices 104, 204 to emit output sound 112, 212 that substantially reduces the average amplitude of the background audio noise. As an example, step 315 may include inducing the signal processor 106, 206 to cause the sound-emitting devices 104, 204 to emit output sounds 112, 212 that are substantially inverted representations of the input signals 110, 210.

As another example, the occupant compartment 108, 208 provided in step 310 may be a passenger compartment 108, 208. Further, for example, the passenger compartment 108, 208 may be included in a passenger conveyance (not shown). As another example, step 310 may include providing a filter 114, 214 in communication with the signal processor 106, 206, and step 315 may include causing the filter 114, 214 to remove a public address or public entertainment audio information signal from the input signal 110, 210 before causing the sound-emitting devices 104, 204 to emit the output sound 112, 212. As an example, the method 300 may be carried out utilizing an occupant compartment 108, 208 including one or an array of passenger seats A, and the occupant compartment 108, 208 may be configured for broadcasting an audio information signal intended to be heard by passengers within the occupant compartment 108, 208 such as a public address audio information signal, a passenger entertainment audio information signal, or both. In that example, step 310 may include configuring the filter 114, 214 for removing such public address and passenger entertainment audio information signals from the input signal 110, 210 before causing the sound-emitting devices 104, 204 to emit the output sound 112, 212. In this manner, the method 300 may cause the output sound 112, 212 to destructively interfere with and thus partially cancel the background audio noise in the occupant compartment 108, 208, and facilitate unimpeded listening to public address and public entertainment audio information signals by passengers within the occupant compartment 108, 208. As an example, step 315 may include causing the system 100, 200 to operate in further ways to minimize interference by the system 100, 200 with broadcasting of a public address or public entertainment audio information signal in the occupant compartment 108, 208. For example, step 315 may include inducing the signal processor 106, 206 to suspend causing emission by the sound-emitting devices 104, 204 of the output sounds 112, 212 during the broadcasting of a public address or public entertainment audio information signal.

In another example, providing a sound detector 102, 202 at step 310 may include providing an array of sound detectors 202 distributed in the occupant compartment 208. Further in that example, providing a sound-emitting device 104, 204 at step 310 may include providing an array of sound-emitting devices 204 distributed in the occupant compartment 208. Additionally in that example, providing a signal processor 106, 206 at step 310 may include providing the signal processor 206 in communication with the array of sound detectors 202 and with the array of sound-emitting devices 204. Also in that example, step 315 may include causing the signal processor 206 to receive an input signal 210 from each of the sound detectors 202, where the input signals 210 are indicative of background audio noise in the occupant compartment 208. Further, step 315 may include causing each of the sound-emitting devices 204 to emit output sound that partially cancels the background audio noise in the occupant compartment 208.

As an example, step 310 may further include providing the array of sound detectors 202 and the array of sound-emitting devices 204 where each one of the sound detectors 202 is paired with one of the sound-emitting devices 204, forming pairs each including a sound detector 202 and a sound-emitting device 204. Further in that example, step 315 may include causing the signal processor 206 to receive a separate input signal 210 from each of the sound detectors 202. Additionally, step 315 may include inducing the signal processor 106, 206 to cause each of the paired sound-emitting devices 204 to emit a separate output sound 212. Further, for example, step 315 may include causing the signal processor 206 to separately analyze each of the separate input signals 210, and may include inducing the signal processor 206 to separately cause each of the sound-emitting devices 204 to emit a separate output sound 212. As another example, step 315 may include partially cancelling the background audio noise by a similar magnitude throughout the occupant compartment 208.

Also, for example, step 310 may include providing, collectively represented by a dashed line defining a three-dimensional region 216, a first pair that includes a first sound detector 202 and a first sound-emitting device 204, adjacent to a first passenger seat A. Further in that example, step 310 may include providing, collectively represented by a dashed line defining a three-dimensional region 218, a second pair that includes a second sound detector 202 and a second sound-emitting device 204, adjacent to a second passenger seat A. In that example, step 315 may include partially cancelling background audio noise extending between the first and second passenger seats located in the three-dimensional regions 216, 218, respectively. Further, for example, step 310 may include configuring the signal processor 206 for causing the first and second sound-emitting devices 204 to substantially reduce an amplitude of background audio noise extending between the first and second passenger seats respectively located in the three-dimensional regions 216, 218.

A sound detector 102, 202 for utilization in the systems 100, 200 and in carrying out the method 300 may as examples include any acoustic transducer device suitable for converting background audio noise sound, received in the vicinity of the acoustic transducer device from a range of directions, into an analog or digital signal. As examples, the analog or digital signal may be an electronic or optical signal. For example, the acoustic transducer device may be a microphone. A sound-emitting device 104, 204 for utilization in the systems 100, 200 and for utilization in carrying out the method 300 may as examples include any acoustic sound-producing device suitable for generating sound directed in a range of directions from and corresponding to an analog or digital signal that represents acoustic sound. For example, a sound-emitting device 104, 204 may include a loudspeaker.

A signal processor 106, 206 may include, as an example, a digital signal processor configured for receiving the input signals 110, 210 and for causing the sound-emitting devices 104, 204 to emit the output sounds 112, 212 of the systems 100, 200 or for carrying out the method 300. It is understood throughout this specification that the systems 100, 200 include suitable signal conductors linking together the sound detectors 102, 202, the sound-emitting devices 104, 204, and the signal processor 106, 206 for operability of the systems 100, 200. A system 100, 200 may include a plurality of signal processors 106, 206. Signal conductors may include, as examples, metallic conductors, optical conductors, wireless linkages, or combinations. In systems 200 including an array of sound detectors 202 and an array of sound-emitting devices 204, the input signals 210 may be carried into the signal processor 206 from the sound detectors 202 via a suitable signal input interface (not shown). Likewise in such systems 100, 200, the output sounds 212 may be distributed from the signal processor 206 to the sound-emitting devices 204 via a suitable signal output interface (not shown). In an example, the system 100, 200 may include one or more signal amplifiers (not shown) for amplifying the output sounds 112, 212 for effectively driving the sound-emitting devices 104, 204. Filters 114, 214 for the systems 100, 200 may be implemented in hardware (not shown), software, or a combination. In examples of a system 200 having paired sets each including a sound detector 202 and a sound-emitting device 204, the pairing may for example be virtually implemented by configuration of the signal processor 206; or as an example by providing a plurality of separate systems 100 each including a sound detector 102, a sound-emitting device 104, and a signal processor 106.

It is understood throughout this specification that one or more system functions or method steps described in connection with the systems 100, 200 and the method 300 may be performed by a signal processor 106, 206 implemented in hardware and/or software. Additionally, steps of the method 300 may be implemented completely in software executed within a signal processor 106, 206. Further, for example, the signal processor 106, 206 may execute algorithms suitable for configuring the systems 100, 200 or the method 300 for partially cancelling background audio noise or for reducing average amplitudes of background audio noise from selected noise-producing sources in end-use applications for selected occupant compartments 108, 208. Examples of signal processors 106, 206 include: a microprocessor, a general purpose processor, a digital signal processor, or an application-specific digital integrated circuit. If the method 300 is performed by software, the software may reside in software memory (not shown) and/or in the signal processor 106, 206 used to execute the software. The software in a software memory may include an ordered listing of executable instructions for implementing logical functions, and may be embodied in any digital machine-readable and/or computer-readable medium for use by or in connection with an instruction execution system, such as a processor-containing system.

The systems 100, 200 may, for example, be utilized as noise reduction systems in an occupant compartment 108, 208. As examples, the occupant compartment 108, 208 may form all or part of (not shown) a building, amphitheatre, passenger seating or waiting area, mobile industrial machine, or another structure, any of which may or may not be partially or fully defined by a floor, walls and/or a ceiling. Mobile industrial machines (not shown) may include, as examples, farming equipment, mining equipment, construction equipment, and load-lifting and load-transporting equipment such as cranes and forklifts. For example, the occupant compartment 108, 208 may be a passenger compartment configured for being occupied by one or a plurality of people. Further, for example, the passenger compartment 108, 208 may be included in a passenger conveyance (not shown). In examples, the passenger conveyance may be a passenger transport vehicle such as an automobile, a bus, a truck, an aircraft, a ship, a boat, a submarine, a spacecraft, or a railroad car. Likewise, the method 300 may be utilized for partially cancelling background audio noise within an occupant compartment 108, 208, of which the systems 100, 200 disclosed herein are only examples.

The above discussion regarding the system 100 has analogous applicability in the system 200 and in the method 300; and the discussion of the system 100 accordingly is deemed incorporated into the discussion of the system 200 and into the discussion of the method 300. The above discussion regarding the system 200 has analogous applicability in the system 100 and in the method 300; and the discussion of the system 200 accordingly is deemed incorporated into the discussion of the system 100 and into the discussion of the method 300. The above discussion regarding the method 300 has analogous applicability in both of the systems 100, 200; and the discussion of the method 300 accordingly is deemed incorporated into the discussions of both of the systems 100, 200.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. A system, comprising:
a sound detector;
a sound-emitting device; and
a signal processor in communication with the sound detector and with the sound-emitting device;
wherein the sound detector and the sound-emitting device are in audio communication with an occupant compartment; and
wherein the signal processor is configured for receiving an input signal from the sound detector being indicative of background audio noise in the occupant compartment, and for causing the sound-emitting device to emit output sound that partially cancels the background audio noise in a manner responsive to the received input signal.

2. The system of claim 1, wherein the signal processor is configured for causing the sound-emitting device to emit output sound that interferes destructively with the background audio noise in the occupant compartment.

3. The system of claim 1, wherein the occupant compartment is in a mobile industrial machine.

4. The system of claim 1, wherein the occupant compartment is in a passenger conveyance.

5. The system of claim 4, wherein the passenger conveyance is selected from a group consisting of: an automobile, a bus, a truck, an aircraft, a ship, a boat, a submarine, a spacecraft, and a railroad car.

6. The system of claim 1, wherein the signal processor includes a filter configured for removing an audio information signal from the input signal before the output sound is generated.

7. The system of claim 6, wherein the audio information signal is selected from a group consisting of: a public address audio information signal, and a passenger entertainment audio information signal.

8. A system, comprising:
an array of sound detectors;
an array of sound-emitting devices; and
a signal processor in communication with the array of sound detectors and with the array of sound-emitting devices;
wherein the array of sound detectors and the array of sound-emitting devices are in audio communication with an occupant compartment; and
wherein the signal processor is configured for receiving from each of the sound detectors an input signal being indicative of background audio noise in the occupant compartment, and for causing the sound-emitting devices to emit output sound that partially cancels the background audio noise in a manner responsive to the received input signals.

9. The system of claim 8, wherein the signal processor is configured for analyzing a different one of the input signals in causing each of the sound-emitting devices to emit output sound.

10. The system of claim 8, wherein the signal processor is configured for causing the amplitude of the background audio noise to be substantially reduced throughout a substantial region of the occupant compartment.

11. The system of claim 8, wherein the occupant compartment is in a passenger conveyance.

12. The system of claim 8, wherein each one of the sound detectors is paired with one of the sound-emitting devices, each pair including a sound detector and a sound-emitting device; and wherein the signal processor is configured for receiving a separate input signal from each one of the sound detectors and for causing each paired sound-emitting device to emit a separate output sound.

13. The system of claim 12, wherein the occupant compartment includes a first pair of the sound detectors and of the sound-emitting devices adjacent to a first passenger seat, and a second pair of the sound detectors and of the sound-emitting devices adjacent to a second passenger seat; and wherein the signal processor is configured to cause the background audio noise in a region extending between the first and second passenger seats to be partially cancelled.

14. A method, comprising:
providing a sound detector and a sound-emitting device in communication with an occupant compartment, and providing a signal processor in communication with the sound detector and with the sound-emitting device; and
causing the signal processor to receive an input signal from the sound detector, the input signal being indicative of background audio noise in the occupant compartment, and inducing the signal processor to cause the sound-emitting device to emit output sound that partially cancels the background audio noise in a manner responsive to the received input signal.

15. The method of claim 14, wherein the occupant compartment is in a passenger conveyance.

16. The method of claim 14, wherein providing a sound detector includes providing an array of sound detectors; wherein providing a sound-emitting device includes providing an array of sound-emitting devices; wherein providing a signal processor includes providing the signal processor in communication with the array of sound detectors and with the array of sound-emitting devices; and
causing the signal processor to receive an input signal from each of the sound detectors, and causing the array of sound-emitting devices to emit output sound that partially cancels the background audio noise in the occupant compartment.

17. The method of claim 16, wherein each one of the sound detectors is paired with one of the sound-emitting devices, each pair including a sound detector and a sound-emitting device; and
causing the signal processor to receive a separate input signal from each of the sound detectors, and inducing the signal processor to cause each of the paired sound-emitting devices to emit a separate output sound.

18. The method of claim 17, including inducing the signal processor to separately analyze each input signal, and inducing the signal processor to cause each sound-emitting device to separately emit an output sound.

19. The method of claim 17, wherein the cancelling includes reducing an average amplitude of the background audio noise by at least about 1 decibel throughout a substantial region of the occupant compartment.

20. The method of claim 17, wherein a first pair including a sound detector and a sound-emitting device is located adjacent to a first passenger seat, and wherein a second pair including a sound detector and a sound-emitting device is located adjacent to a second passenger seat; and partially canceling the background audio noise in a region extending between the first and second passenger seats.
